(19) United States
(12) Patent Application Publication
(10) Pub. No.: US 2011/0179385 A1
(43) Pub. Date: Jul. 21, 2011

(54) CONTENT CLASSIFICATION UTILIZING A REDUCED DESCRIPTION PALETTE TO SIMPLIFY CONTENT ANALYSIS

(76) Inventors: Wencheng Li, Santa Clara, CA (US); Zihai Shi, San Francisco, CA (US); Gabriel Sidhom, Mill Valley, CA (US)

(21) Appl. No.: 13/120,398

(22) PCT Filed: Sep. 23, 2009
(86) PCT No.: PCT/IB2009/055099

§ 371 Date: Mar. 22, 2011

Related U.S. Application Data
(60) Provisional application No. 61/099,893, filed on Sep. 24, 2008.

(51) Int. Cl. G06F 3/048

(52) U.S. Cl. 715/810

(57) ABSTRACT

A system, method, device and interface for classifying content. The system, method, device and interface provide for rendering content, providing to a user a plurality of reaction indicators, receiving a user selection of one of the plurality of reaction indications, and associating the user selected reaction indication with a portion of the content that is being rendered at the time of receiving the user selection.

### CROSS-REFERENCES TO RELATED APPLICATIONS

This application is a National Stage Application of International Application No. PCT/IB2009/055099, filed Sep. 23, 2009, incorporated herein by reference thereto, which claims the benefit of U.S. Provisional Patent Application No. 61/099,893, filed Sep. 24, 2008, incorporated herein by reference thereto.

### FIELD OF THE PRESENT SYSTEM

The present system relates to at least one of a method, user interface and apparatus for classifying content utilizing a reduced description palette to simplify content analysis and presentation of separate content portions.

### BACKGROUND OF THE PRESENT SYSTEM

Content, such as digital audio visual content is pervasive in today's society. Parties are presented with a vast array of sources from which content may be selected included optical media and network provided, such as may be available over the Internet. A major problem exists in that with the vast availability of content, such as audio visual content, there are a limited number of ways in which the content has been classified. One system which has been provided is a genre classification system in which, for example, audio visual content is classified in broad categories, such as drama, comedy, action, etc. While this system does provide some insight into what may be expected while watching the audio visual content, the typical classification is broadly applied to an entire audio visual presentation and as such, does not provide much insight into different segments of the audio visual content. For example, while in general, the entire audio visual presentation may be generally classified as belonging in an action genre, different portions of the audio visual content may be related to comedy, drama, etc. Accordingly, the broad classification of the audio visual content ignores these sub-genres that represent portions of the content and thereby, may fail to attract the attention of a party that may have an interest in these sub-genres.

Recommendation system have been provided that utilize a broader semantic description, that may be provided by the producers of the audio visual content and/or may be provided by an analysis of the portions of the audio visual content directly. These systems typically compare the semantic description to a user profile to identify particular audio visual content that may be of interest. Other systems, such as U.S. Pat. No. 6,173,287 to Eberman, incorporated herein as if set out its entirety, utilizes metadata to automatically and semantically annotate different portions of the audio visual content to enable retrieval of portions of the audio visual content that may be of interest. Problems exist with this system in that the analysis of audio and visual portions of the audio visual content is very complex and oftentimes produces less than satisfactory results. Generally, due to wide differences in terms applied to the semantic annotation, search results tend to be erratic depending on the particular terms utilized for annotation and search. For example, a sequence relating to and annotated with automobile, may not be retrieved by a search term of “car” since searches tend to be literal.

Other systems have provided tools to annotate portions of audio visual content using elements such as timestamps, closed-captioned text, editor supplied “most-important” portion indications, etc., but these systems have all suffered from the vast variety of descriptive terms associated with content (e.g., audio, audio visual, text, etc.) and also utilized for content retrieval. The music genome project has attempted to classify audio content by identifying over 400 attributes, termed genes that may be applied to describe an entire song. A given number of genes represented as a vector are utilized for each song. Given a vector for a song utilized as a searching seed, similar songs are identified using a distance function wherein a distance function from the seed song is utilized to identify the similar songs. While this system simplifies elements (genes) that may be used to identify a song, the system still utilizes a complex classification system associated with songs that make it impossible for users to participate in the classification. It is for this reason that the system utilizes professional technicians to apply genes to each song. Further, this system also applies genes to the entire song and thereby provides no ability to identify different portions of the song that may diverge from the general classification applied to the entire song.

Social networks have developed that are accessible over the Internet such as YouTube, wherein videos are uploaded to a video server and viewers are provided with an ability to comment on the videos. Users may also share comments and suggested videos to the general public or to selected users to inspire others to view the videos and provide further comments. Playlists of favorite videos may also be compiled and shared. While these systems have found general acceptance and use, the similar problems of broad semantics utilized for commenting on the videos and an inability to identify individual portions of the audio video content still persist.

None of these prior systems provides a system, method, user interface and device to classify content utilizing a reduced description palette to simplify content analysis and facilitate identification and retrieval of content portions.

### SUMMARY OF THE PRESENT SYSTEM

It is an object of the present system to overcome disadvantages and/or make improvements in the prior art.

The present system includes a system, method, device and interface for collecting user feedback, such as emotional feedback, on portions of rendered content, such as audio-visual content, and providing recommendations based on the pattern of such feedback.

In accordance with the present system, content classification may include rendering content, providing to a user a plurality of reaction indications, receiving a user selection of one of the plurality of reaction indications, and associating the user selected reaction indication with a portion of the content that is being rendered at the time of receiving the user selection. The reaction indications may be provided as pictorial representations of a limited number of potential user reactions to the rendered content. The reaction indications may be rendered as emoticons. The reaction indications may be rendered as representative of potential user emotional reactions to the rendered content.

In accordance with the present system, receiving the user selected reaction indication may be received from a plurality of users in response to the rendered content. The user selected reaction indications may be tallied from the plurality of users to produce a tallied reaction indication. The tallied reaction indication may be provided to the user along with the content. The tallied reaction indication may be associated with a portion of the content. The tallied reaction indication may be one of a plurality of tallied reaction indications. In accordance with an embodiment of the present system, each of the tallied reaction indications may be associated with a different portion of the content.

Each of the user selected reaction indications may be associated with a timestamp identifying a temporal point in the rendered content. A standard deviation of the timestamps may be determined. Each nearest neighbor pair of reaction indications may be associated to a corresponding cluster if the corresponding nearest neighbor pair of timestamps is equal or less than the standard deviation. A portion of the content may be identified based on the timestamps of reaction indications corresponding to a given cluster. The user selected reaction indication may be compared with other users reaction indications for the content. Further content may be recommended to the user based on the comparison.

### BRIEF DESCRIPTION OF THE DRAWINGS

The invention is explained in further detail, and by way of example, with reference to the accompanying drawings wherein:

FIG. 1 shows a graphical user interface in accordance with an embodiment of the present system;

FIG. 2 shows a flow diagram that illustrates a content reviewing process in accordance with an embodiment of the present system;

FIG. 3 shows a heat map in accordance with an embodiment of the present system;

FIG. 4 shows a further graphical user interface in accordance with an embodiment of the present system;

FIG. 5 shows a still further graphical user interface in accordance with an embodiment of the present system; and

FIG. 6 shows a system in accordance with an embodiment of the present system.

### DETAILED DESCRIPTION OF THE PRESENT SYSTEM

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, circuits, tools, techniques and methods are omitted so as not to obscure the description of the present system. It should be expressly understood that the drawings are included for illustrative purposes and do not represent the scope of the present system. In the accompanying drawings, like reference numbers in different drawings may designate similar elements.

For purposes of simplifying a description of the present system, the terms “operatively coupled”, “coupled” and formatives thereof as utilized herein refer to a connection between devices and/or portions thereof that enables operation in accordance with the present system. For example, an operative coupling may include one or more of a wired connection and/or a wireless connection between two or more devices that enables a one and/or two-way communication path between the devices and/or portions thereof. For example, an operative coupling may include a wired and/or wireless coupling to enable communication between a content server and one or more user devices. A further operative coupling, in accordance with the present system may include one or more couplings between two or more user devices, such as via a network source, such as the content server, in accordance with an embodiment of the present system.

The term rendering and formatives thereof as utilized herein refer to providing content, such as digital media, such that it may be perceived by at least one user sense, such as a sense of sight and/or a sense of hearing. For example, the present system may render a user interface on a display device so that it may be seen and interacted with by a user. Further, the present system may render audio visual content on both of a device that renders audible output (e.g., a speaker, such as a loudspeaker) and a device that renders visual output (e.g., a display). To simplify the following discussion, the term content and formatives thereof will be utilized and should be understood to include audio content, visual content, audio visual content, textual content and/or other content types, unless a particular content type is specifically intended, as may be readily appreciated.

The system, device(s), method, user interface, etc., described herein address problems in prior art systems. In accordance with an embodiment of the present system, a device and technique is provided for classifying content utilizing a user input and a reduced description palette to simplify content analysis and presentation of separate content portions. Reaction indications may provide a simplified graphical user interface for receiving a reaction (e.g., level of interest, emotional reaction, character identification, etc.), from a user in response to rendered content. In addition, the present system may collect other statistics related to the user and/or user device in accordance with the present system, such as a relative time of an action, geolocation, network, etc.

Significantly, in accordance with the present system, a reaction indication palette is provided that includes a limited number of selectable elements to identify a user's reaction to the rendered content. For example, the reaction palette may be related to emotions that the user may be feeling at the time that the user is experiencing rendered content (e.g., watching/listening to audio visual content, etc.). It is known that emotions are both a metal and psychological state that may be brought about by what a user is experiencing, such as what is experienced by the user when content is rendered.

By providing the user a palette of reaction indications (e.g., such as related to emotions) for selection while content is being rendered, the present system enables the user to select an indication of a reaction to content, such as an emotional reaction) for association with a portion or particular point of the content (e.g., a frame of video or audio-visual content) at the time of rendering. The present system enables the user to select reaction indications (e.g., such as emotion indications) throughout the rendering of the content. In this way, the present system enables the content to be classified by the range of emotions exhibited by the user. Further, by associating the range of emotion indications with particular portions or points of the content, for example by association with a timestamp indicating the temporal portion of the content when the reaction indication is provided, individual points or portions of the content may also be separately classified. In this way, while in prior systems content may be generally classified as “action”, the present system may classify particular portions of the content as being related to love, hate, disgust, and/or other reactions exhibited by the user.

A model is known that illustrates a classification of emotions that may be exhibited by a user while content is being rendered. This model is discussed at the web site “en.wikipedia.org/wiki/Robert_Plutchik”, the contents of which are incorporated herein as if set out in its entirety. The emotions may be classified into general categories such as aggressiveness, contempt, anger, fear, sadness, disgust, surprise, curiosity, acceptance and joy, etc., and emotion indications of those emotions may be provided to the user in the form of the reaction indication palette discussed herein. By providing a given set of emotion indications, a much simplified UI is provided to the user for providing reaction indications during the rendering of the content as discussed further herein.

Illustratively, the selectable elements of the palette may be provided in a form of emoticons. In prior systems, an emoticon is a rendered symbol or combination of symbols that are typically utilized to convey emotion in a written passage, such as may be provided during instant messaging. In accordance with an embodiment of the present system, one or more of the rendered symbol(s) may be selected by a user to pictorially represent the user's reaction to one or more given rendered content portions of a single (entire) content item.

In accordance with the present system, an emoticon may be utilized to provide a ready visual association to facilitate first the annotation intended for the content portion and second, a review of annotations provided. The user may be enabled to individually annotate content portions within a user interface (UI), such as a graphical user interface (GUI).

The GUI may be provided by an application running on a processor, such as part of a computer system. The visual environment may be displayed by the processor on a display device and a user may be provided with an input device to influence events or images depicted on the display device. GUI's present visual images which describe various visual metaphors of an operating system, an application, etc., implemented on the processor/computer including rendering on a display device.

The present system enables a user to annotate one or more portions of content (e.g., frames, group of frames, etc.), such as a video, by selecting reaction indications (e.g., emoticons) from a palette of reaction indications provided by the system to the user, or by supplying user comments during a content rendering experience. The reaction indications may be saved and temporally associated with the content. For example, the reaction indications may be associated with the content and timestamps indicating a time relative to the content when the reaction indication was provided by the users. The collection of such input from users may be used to build a reaction indication database that may be provided as metadata associated with the content generally, and particular content portions and times. In this way, an embodiment of the present system may be used to categorize content, provide recommendations, and may be utilized in determining which portion of content may be of interest to the user.

The present system may provide content, annotations that are associated with portions of the content, timestamps that may be utilized to identify which part (e.g., having a temporal beginning and end) or place (e.g., a temporal point in the content) in the content the portions are associated with, and in some embodiments, an indication as to the source (e.g., buddies) of annotations. In this way, viewers may choose content portions based on the annotation(s) from someone they know. For example, User A may choose to view a collection of frames of video content that have been annotated by a friend or someone in his or her online community.

In operation, a user typically moves a user-controlled object, such as a cursor or pointer, across a computer screen and onto other displayed objects or screen regions, and then inputs a command to execute a given selection or operation. In accordance with the present system, the selection may be a selection of a reaction indication rendered as a portion of the UI. Selection of a reaction indication may result in an association of the reaction indication with the content portion being rendered at the time of the selection. A timestamp may also be associated the reaction indication and the content. The timestamp is utilized in accordance with the present system to identify a temporal position of the content wherein the reaction indication is selected by the user.

In accordance with the present system, an operation may result from a user selecting a portion of the content for rendering. Other applications or visual environments also may provide user-controlled objects such as a cursor for selection and manipulation of depicted objects in a multi-dimensional (e.g., two-dimensional) space.

The user interaction with and manipulation of the computer environment is achieved using any of a variety of types of human-processor interface devices that are operationally coupled to the processor controlling the displayed environment. A common interface device for a user interface (UI), such as a graphical user interface (GUI) is a mouse, trackball, keyboard, touch-sensitive display, etc. For example, a mouse may be moved by a user in a planar workspace to move a visual object, such as a cursor, depicted on a two-dimensional display surface in a direct mapping between the position of the user manipulation and the depicted position of the cursor. This is typically known as position control, where the motion of the depicted object directly correlates to motion of the user manipulation.

An example of such a GUI in accordance with an embodiment of the present system is a GUI that may be provided by a computer program that may be user invoked, such as to enable a user to select and/or classify/annotatate content. In accordance with a further embodiment, the user may be enabled within a visual environment, such as the GUI, to classify content utilizing a reduced description palette to simplify content analysis, presentation, sharing, etc., of separate content portions in accordance with the present system. To facilitate manipulation (e.g., content selection, annotation, sharing, etc.) of the content, the GUI may provide different views that are directed to different portions of the present process.

For example, the GUI may present a typical UI including a windowing environment and as such, may include menu items, pull-down menu items, pop-up windows, etc., that are typical of those provided in a windowing environment, such as may be represented within a Windows™ Operating System GUI as provided by Microsoft Corporation and/or an OS X™ Operating System GUI, such as provided on an iPhone™, MacBook™, iMac™, etc., as provided by Apple, Inc., and/or another operating system. The objects and sections of the GUI may be navigated utilizing a user input device, such as a mouse, trackball, finger, and/or other suitable user input. Further, the user input may be utilized for making selections within the GUI such as by selection of menu items, window items, radio buttons, pop-up windows, for example, in response to a mouse-over operation, and other common interaction paradigms as understood by a person of ordinary skill in the art.

Similar interfaces may be provided by a device having a touch sensitive screen that is operated on by an input device such as a finger of a user or other input device such as a stylus. In this environment, a cursor may or may not be provided since location of selection is directly determined by the location of interaction with the touch sensitive screen. Although the GUI utilized for supporting touch sensitive inputs may be somewhat different than a GUI that is utilized for supporting, for example, a computer mouse input, however, for purposes of the present system, the operation is similar. Accordingly, for purposes of simplifying the foregoing description, the interaction discussed is intended to apply to either of these systems or others that may be suitably applied.

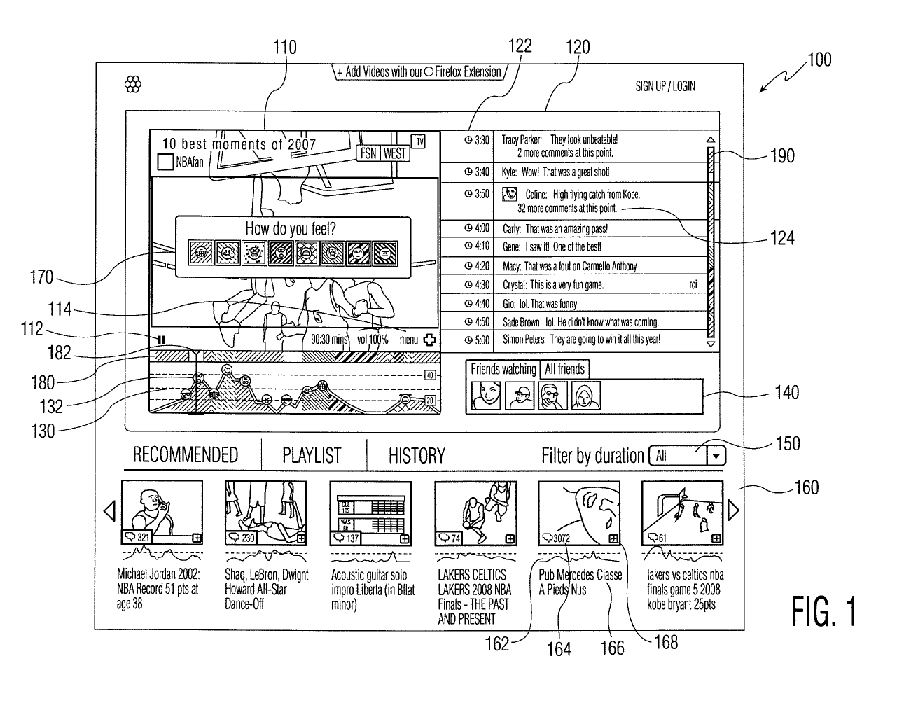

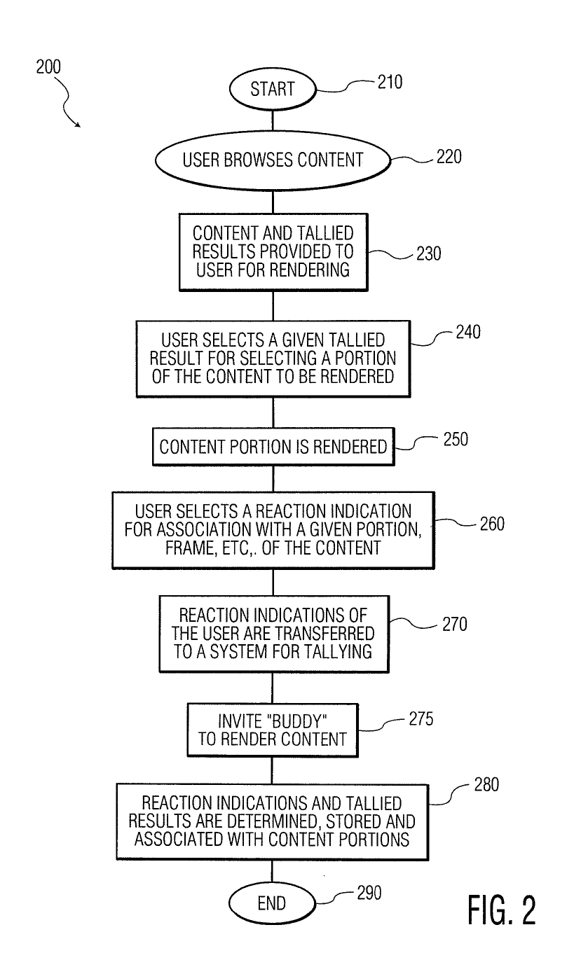

FIGS. 1 and 2 will be discussed below to facilitate a discussion of illustrative embodiments of the present system. FIG. 1 shows one embodiment of the present system, wherein a GUI 100 is provided having a content rendering portion 110 and one or more other portions, such as a user comment portion 120, a buddy portion 140, one or more heat mapping portions, such as a heat line graph 180, a heat map 130, a heat comment graph 190, etc. As a verbal and visual metaphor, the term heat and differences in rendering user reaction indications (e.g., different hatching, scoss-hatching, colors, etc. rendered on a display) corresponding to different heat levels, are utilized to represent reactions, such as impressions, feelings, emotions, etc., that are elicited by one or more parties (e.g., a current user and/or a plurality of prior users) when content is rendered.

These reactions and a reduced set of representations thereof are inventively associated with content portions and are utilized in accordance with the present system to annotate the content portions, for example during a rendering of the content. The reduced set of reactions enables a simplified description of the content portions which facilitates annotation, searching, rendering, such as selective rendering, sharing, recommendation, etc., of the content. In accordance with the present system, the use of a reduced reaction set for annotation of the rendered content provides a greatly simplified system, method, UI, etc., for annotating the content during a reviewing process as well as providing a reliable way for users to retrieve content portions that may be of interest as described further herein.

FIG. 2 shows a flow diagram 200 that illustrates a content reviewing process in accordance with an embodiment of the present system. In operation, the process may start during act 210 when a user launches a web browser that is enabled in accordance with the present system. The user may browse content provided by a content server during act 220 as may be readily appreciated. The content may also be provided from a local storage device, such as a personal video recorder and/or other local storage device, such as a hard drive, optical disk, etc.

In accordance with an embodiment of the present system, the interface for interaction may include a browser that provides portions that facilitate the selection and/or initiation of content rendering. For example, a program in accordance with the present system may provide an address bar wherein an address of the content may be provided by the user as may be typical within a web browser. In response, the content including tallied results (e.g., a collection of reaction indications from a plurality of users as discussed further herein) may be provided to the user during browsing of the content on the server and/or the content and the tallied results may be transferred to a user device, such as a laptop computing device, set-top box, etc. during act 230.

Within the GUI 100, a user may choose to render the content during act 240. In accordance with the present system, content may be rendered within the content rendering portion 110 and/or the content may be rendered within a separate rendering window (e.g., for visual content) and/or may be rendered on a content rendering device, such as an audio speaker. Content may be rendered as in prior systems (e.g., from a beginning to an end of the content), or the user may choose to render selected content portions.

The GUI 100 may provide interaction elements for a selection and/or rendering initiation, etc., of the content, such as may be provided by a play selector 112, illustratively shown as a play/pause indication, and/or may be provided by a menu indication 114, selection of which may initiate a pop-up menu structure as may be readily appreciated by a person of ordinary skill in the art. The pop-up menu structure may provide interaction elements (radio buttons, dialogue boxes, etc.) that may facilitate a search of/for content, selection of content, “buddy” activities, such as sharing of content, reaction indications, etc.

In accordance with the present system, other elements may be utilized for initiation of rendering of portions of the content. For example, the GUI 100 in accordance with the present system, may provide one or more of the heat map 130, the heat line graph 180, and/or the heat comment graph 190 to facilitate selection of a content portion of the content (e.g., a selected portion of the entire content). For example, the heat map 130, the heat line graph 180, and/or the heat comment graph 190 may be colored, differentially shaded, differentially hatched, differentially cross-hatched, etc., corresponding to different reactions, such as emotions. For example, a yellow color may be provided for a “laughing” reaction, a light green color for a “love” reaction, a dark green for a “terror” reaction, a light blue color for a “surprised” reaction, a dark blue color for a “crying” reaction, a purple color for an “embarrassed” reaction, a red color for an “angry” reaction, and an orange color for a “vigilance” reaction. These colors, shades, hatchings, cross-hatching, etc., may be provided along with each one of the palette of reaction indications, such as related to these emotions, to enable the user to appreciate the relation of the differential portions provided in the heat map 130, the heat line graph 180, and/or the heat comment graph 190.

By providing colors, shades, and/or other visual means of differentiating different portions of one or more of the heat map 130, the heat line graph 180, and/or the heat comment graph 190, these differential renderings may be utilized to indicate a reaction distribution. For example, by visually differentiating between differing reactions indications, a simple visual inspection of the heat map 130, the heat line graph 180, and/or the heat comment graph 190 may provide an indication of the reaction distribution throughout portions of the content and thereby may provide an indication of portions of the content that may be of interest to a user.

Illustratively, differential hatching and cross-hatching is utilized to identify different portions of the user interface, such as portions of the heat map 130, the heat line graph 180, and the heat comment graph 190. This is provided in the figures as one illustrative system for differentially rendering portions of the UI. It may be readily appreciated that differential coloring and/or combinations of differential coloring and hatching, cross-hatching, etc., may also be readily applied to distinguish between portions of the UI including the heat map 130, the heat line graph 180, and/or the heat comment graph 190.

Further, differentially indicated portions are illustratively shown having borders wherein the differential rendering changes from one rendering to another. In accordance with one embodiment of the present system, the borders of differentially rendered portions may blend such that a transition portion between the differentially rendered portions may transition from one rendering (e.g., color, hatching, cross-hatching, etc.) to another. For example, in portion of the UI, such as the heat may 130, a portion of the heat may that is rendered in a “yellow” color may border a portion of the heat map that is rendered in a “green” color. In one embodiment in accordance with the present system, the yellow color rendering may transition to the green color rendering through a transition portion. The transition portion may be rendered in varying degrees of yellow and green coloring tending to be more yellow towards the portion rendered solely in the yellow color and tending to be more green towards the portion rendered solely in the green color. In this way, a user may be provided with a ready visual appreciation for how the different portions of the reaction indications temporally vary.

Further, interaction with one or more of the heat map 130, the heat line graph 180, and/or the heat comment graph 190 (e.g., left-clicking a portion of one or more of the heat map 130, the heat line graph 180, and/or the heat comment graph 190), may in one embodiment, result in rendering of a corresponding portion of the content. A line indication 182 may be provided though one or more of the heat map 130, the heat line graph 180, and/or the heat comment graph 190 to indicate which portion of the content is currently being rendered. In one embodiment of the present system, a dragging of a line indication, such as the line indication 182, may be utilized to select a portion of the content for rendering. In the same or a different embodiment of the present system, a simple selection action, such as a left-click within a portion, such as the heat map 130, the heat line graph 180, and/or the heat comment graph 190, may result in a rendering of a portion of the content that temporally corresponds with the portion of the UI that is selected.

In accordance with the present system, tallied results as further discussed, may be provided as a portion of the heat map 130, such as tallied result 132 showing a “surprised emoticon” for indicating a tallied result of “surprised”. The heat map 130, in accordance with an embodiment of the present system has a horizontal axis which represents a timeline of the content with a left-most portion of the heat map 130 representing a beginning of the content and a right-most portion of the timeline representing an end of the content. The heat map 130 further may have a vertical axis that represents the number of reaction indications that have been provided by users. Naturally, other axis or orientations may be suitably applied.

As may be readily appreciated, the granularity of the horizontal and vertical axis may be dynamically altered in accordance with an embodiment of the present system based on a total rendering time of the content and based on the number of reaction indications that are provided for the content. For example, for content that has received hundreds of responses for given content portions, the granularity of the vertical axis of the graph may be in tens, meaning that an indication of “40” may represent forty, tens, or four hundred tallied results for a given content portion.

The heat map 130 provides an indication of tallied results, for example in a form of emoticons distributed horizontally along the heat map 130. The tallied results may also be utilized by a user to identify a content portion that is of interest and/or to control rendering of a content portion. For example, a user may select a content portion by “left-clicking” a mouse button when a cursor, corresponding to the mouse position within the GUI, is positioned on and/or adjacent to a tallied result that appears to the user to be of interest. Naturally, a content portion may also be selected by selection of a comment provided in the user comment portion which includes an indication 124 of the number of comments associated with individual content portions. Lastly, in one embodiment of the present system, the heat comment graph 190, which provides an indication of reaction distribution as discussed above, may also be selected to initiate content rendering. As previously discussed the heat comment graph 190 also indicates a distribution of reaction indications in a form of differential rendering of portions of the heat comment graph 190, such as differential coloring, shading, hatching, cross-hatching, etc. In any event and regardless of which portion of the GUI 100 is utilized for selecting rendering of a content portion, after selection by the user, the present system initiates rendering of the content portion during act 250.

During rendering of the content, the user may have a reaction to a portion of the content and through the present system, may decide to provide a reaction indication for association with a given portion, frame, scene, etc., of the content during act 260. In accordance with an embodiment of the present system, the reaction indications 170 provide a simplified graphical user interface for receiving a reaction selection by a user. In accordance with the present system, a reaction indication palette is provided, for example in response to a “mouse-over” rendered content. In accordance with the present system, the reaction indication palette includes a limited number of selectable elements to identify a user's reaction to rendered content. Illustratively, the selectable elements may be provided in a form of emoticons. In prior systems, an emoticon is a rendered symbol or combination of symbols that are typically utilized to convey emotion in a written passage, such as may be provided during instant messaging. In accordance with an embodiment of the present system, one or more of the rendered symbol(s) may be selected by a user to pictorially represent the user's reaction to rendered content, such as the emotions the user exhibits during portions of the content. In accordance with the present system, an emoticon provides a ready visual association to facilitate first the annotation intended for the content portion and second, a review of annotations provided.

In accordance with the present system, by providing a simplified palette of potential reaction indications, a process of the user providing a reaction indication is greatly simplified. In prior system, the user needed to put into words, what reaction was elicited by a content portion and provide a response in a form of comments to the content portion. This system placed significant burdens on the user to formulate a reaction/comment in words and edit the comment to ensure that it makes sense. In the present system, the simplified palette of potential reaction indications eliminates the prior barrier to providing a reaction to content portions.

In accordance with an embodiment of the present system wherein a palette of pictorial representations of reaction indications are provided, such as in a form of emoticons, the barrier to providing a reaction to content portions is greatly reduced. Further, since only a limited number of reaction indications are possible, the burden of tallying reaction indications is also reduced making it much easier to produce meaningful tallied (e.g., aggregated) results. For example, in accordance with an embodiment of the present system, a fixed set of reactions indications, such as related to emotions, may be provided regardless of the user or content. In this way, analysis of the reaction indications is greatly reduced. Further, the present system by greatly simplifying the range of reaction indications that may be provided by the user, may provide recommendations to one type of content, such as musical content, based on reaction indications that are provided based on a different type of content, such as audio visual content. In accordance with the present system, the burden of providing these recommendations is greatly reduced since the range of reaction indications is greatly reduced.

In one embodiment of the present system, a fixed set of reaction indications are provided regardless of the content that is selected and/or rendered. In this way, the present system may greatly simplify reaction indications and analysis of reaction indications, including a recommendation of content. Since a fixed set of reaction indications are provided regardless of the content, content type, etc., comparisons between user reaction indications and reaction indications provided by third parties is also simplified.

In one embodiment of the present system, the palette of reaction indications may be adaptive to the content being rendered. For example, in a case wherein a user is watching content such as an action movie or action oriented animation video, the user may be provided a palette of reaction indications such as emoticons, associated with an action movie palette to select from, thereby enabling classification of video frames based on fights, high drama, etc. When a user is watching a sports video, the user may be provided a sports palette of emoticons to annotate the frames such as with indications of dunks, drop shots, steals, etc., that may be occurring during portions of the content. Alternatively an emoticons palette may be provided with characters associated with the content. For example, a reaction indication may be provided representing Shag when basketball content is being rendered and viewed, or a reaction indication representing Harrison Ford may be provided during rendering of an Indiana Jones movie.

By providing a palette of reaction indications that is suited to a particular content, the provided reaction indications may be ensured to be relevant to the rendered content. However significantly, since the provided palette of reaction indications represents a reduced set of all possible user-based reaction indications (e.g., is controlled set of reaction indications provided to a user for selection, such as not semantically based), tallying and representation of the reaction indications from a plurality of users is greatly simplified from prior systems that typically relied on a semantic comparison of reactions, such as between comments.

In accordance with an embodiment of the present system, reaction indications may be associated with corresponding content portions as annotations that may be stored, shared, tallied, etc., for example, so friends may render the same content, while sharing the annotations to the associated content portions asynchronously, for example in a form of the heat map, such as the heat may 130 depicted in FIG. 1. In this way, the present system, method, UI, etc., enables both commercial and user generated content, such as videos, to be annotated by users, in a far richer way than previously achievable, such as through prior systems that utilize metadata associated with the content.

In operation, for example, a user may select a rendered reaction indication (e.g., emoticon) such as a “surprise” reaction, “sad” reaction, etc., and associate the selected reaction indication with a content portion or part, such as a frame of video content. The user need not though may, indicate a starting and/or ending portion of the content portion to associate with the reaction indication. In accordance with one embodiment of the present system, the user need only decide on the reaction indication during rendering of the content, although the rendering may be paused at the time though need not be, and the present system will automatically provide the association to the content at the time when the reaction indication is selected. In addition, the present system may associate a time stamp, or other indication to associate the reaction indication with the portion of the content rendered at the time of providing the reaction indication.

In accordance with an embodiment of the present system, reaction indications and associated content portions are transferred to a system, such as a system accessed over the Internet (e.g., a content server), which collects this information during act 270. The user may decide to share content, reaction indications, etc., with a buddy during act 275. The collected reaction indications from a plurality of users may be tallied for each portion of the content during act 280 and thereafter, the process may end during act 290. For example, all reactions occurring within some content portion, which may be pre-determined (e.g., every sixty frames of video content, every two seconds, etc.) or may be dynamically determined (e.g., based on two or more reaction indications provided that are associated within a short interval of each other), may be tallied together to identify what reaction is elicited, for example, a majority of the time for the content portion. In tallying, the largest number of the same reaction indications (e.g., surprised) in a determined portion of the content may be associated with the content portion and may be presented as the tallied results (e.g., the tallied result 132) shown in the heat map.

In accordance with a further embodiment of the present system, a rise in the number of received reaction indications from a plurality of users may be utilized to identify a beginning of a content portion and/or an end of a previous content portion. Further, a decline in or end of received reaction indications for a portion of the content may be utilized to identify and end to a content portion. In this way, the portions of the reaction indications between the transitions from increasing to decreasing reaction indication may be indicated in the heat map as a pulse. The pulse may be indicated by the tallied result. In accordance with the present system, one tallied result is rendered for each pulse although all reaction indications provided by the users is retained since as the number of reaction indication provided increases, a reaction indication may form a new pulse as additional reaction indications are received. As may be readily appreciated, other results of the tally of reaction indications may be provided in accordance with the present system. The results of the tallying of reaction indications (e.g., the tallied results) are then associated with a given moment or portion of the content with which the reaction indications where previously associated by the users as indicated, for example, as the tallied result.

The present inventors have recognized that surprisingly, content portions (e.g., one or more frames of a video) that elicit a reaction out of users may be identified simply by a fact that a reaction is elicited and indicated as such by a plurality of users for a given portion of content (e.g., frame for video content, group of frames, note for audio content, chord, chords, chord change, word for textual content, words, sentence, paragraph, etc.).

In accordance with an embodiment of the present system, content portions may be identified by a rise in the number of reaction indications received that are associated with a content portion. The present system may utilize a rise and subsequent fall in received reaction indications (herein termed a “pulse” of reaction indications) associated with given portions of the content, such as associated with particular frames of video content, that are in close temporal proximity, to identify a program portion. In accordance with the present system, the corresponding content portion may thereafter be associated with a tallied result of the received reaction indications and be presented on a heat map as previously discussed.

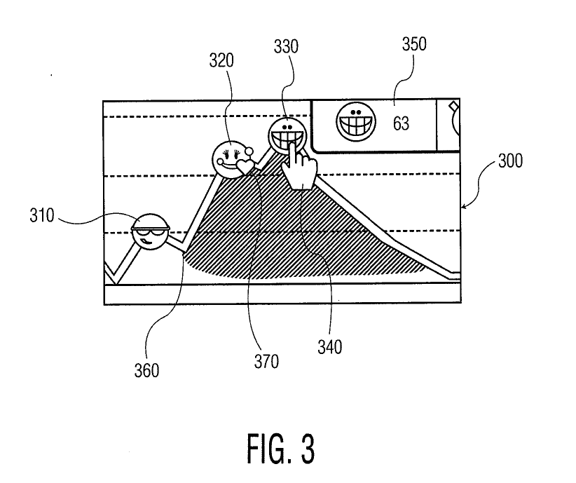

FIG. 3 shows a heat map 300 in accordance with an embodiment of the present system. As shown, three tallied reaction indications are provided, associated with content and particularly, associated with content portions. The heat map 300 is shown having three pulses. Each pulse is identified by a tallied result, such as the tallied results, 310, 320, 330. In accordance with an embodiment of the present system, a pulse is identified as a cluster of reaction indications (e.g., reaction indications that are temporally close together, such as a group (cluster) of reaction indications that are within 5 seconds (content rendering time) of each other for a content portion or part and that are received from a plurality of users, and are associated with a portion of content.

In accordance with an embodiment of the present system, an algorithm of detecting a pulse may analyze reaction indication input distributions base on factors, such as noise level, distance of individual points, standard deviation from clusters of reaction indications, etc. A simple algorithm may use a fixed or dynamic threshold to cluster all the input points (e.g., frames associated with reaction indications) to identify the pulse.

In one embodiment in accordance with the present system, a standard deviation calculation may be utilized to determine pulses. For example, for video content, there may be reaction indications with each having a corresponding timestamp {c1, c2 . . . cn}. A collection D {d1, d2 . . . do−1} of nearest neighbor distributions may be determined based on the timestamps for each reaction indication, wherein di=c(i+1)−(ci). For collection D, the standard deviation D′ may be calculated. The standard deviation D′ for all provided reaction indications may thereafter be utilized as a threshold to measure if two reaction indications belong to the same pulse. For example, if d′=3, and d1=4, d2=2, d3=2, d4=5, d5=2, d6=1, d7=3. In this case, the present system may determine that reaction indications c2, c3, c4 belong to one pulse. C1 and c5, which are beyond the standard deviation are treated as islands, and will not be tallied (e.g., treated as noise) for determination of the tallied result for the pulse. Reaction indication c6, c7 are within the standard deviation and may be determined to be a portion of a second pulse.

Surprisingly, it has been found by the present inventors, that reaction indications which are temporally close together often describe one content portion, such as a scene. For example, normally a video contains several scenes, which may be identified in accordance with an embodiment of the present system by identifying reaction indications that are temporally clustered together. For example, between reaction indication 310 and reaction indication 320, there is shown in the heat map 300, a transition 360 in a number of reaction indications provided from a decreasing number of reaction indications to the left of the transition 360 to an increasing number of reaction indications to the right of the transition 360. In this way, the transition point 360 may be identified as a beginning point for a portion of the content that is identified by the tallied reaction indication 320. Similarly, a transition 370 in a number of reaction indications provided from a decreasing number of reaction indications to the left of the transition 370 to an increasing number of reaction indications to the right of the transition 370 may be utilized to identify an end of the content portion identified by the tallied reaction indication 320. For example, a statistical approach may be applied, for example utilizing a standard deviation algorithm to determine the borders of the pulse, for example, as described herein.

In accordance with the present system, the pulses may be utilized to determine those scenes. By identifying content portions such as by identifying pulses in a video, identifying content portions utilizing the pulses/content portions and associating tallied reaction indications within those pulses/content portions, the present system enables users to select content portions of the content, such as video content, through use of the tallied reaction indications. Naturally, other systems may be utilized to define and/or refine a content portion. For example, a cluster of reaction indications may be utilized to identify a general portion of content for a content portion. Thereafter, a search prior and subsequent to the general portion of content may be conducted to identify a cut/fade/black frame, chord change, beginning/end of sentence, etc., to identify the beginning/end of the content portion.

In accordance with the present system, content portions may be selected within a heat map for rendering. For example, left-clicking a tallied result may result in an associated content portion being rendered. Similarly, left-clicking on a point in the heat line graph 180 and/or the heat comment graph 190 may similarly result in rendering of an associated content portion. In accordance with an embodiment of the present system, placement of a cursor over a tallied reaction indication within the heat map may initiate rendering of a pop-up window that includes details of the reaction indications that resulted in the presented tallied reaction indication. For example, In accordance with one embodiment of the present system, placement of a cursor 340 through manipulation of a user input, such as a computer mouse, may produce a pop-up window 350 that includes details of the reaction indications that resulted in the presented tallied reaction indication 330.

By providing tallied reaction indications together with content selected by a user, the tallied reaction indications may be utilized to facilitate an identification of portions of the content that may be of interest. For example, in response to a user selecting content while browsing a website wherein content, such as audio visual content is provided (e.g., YouTube.com), the content may be transferred to the user in addition to the tallied reaction indications associated with the audio visual content portions. The system in accordance with the present system, such as provided by a device running a web browser, renders the audio visual content together with the tallied results such as provided in FIG. 1. A user reviewing the tallied results, such as provided in a heat map, may choose to render a given portion of the content by selecting a given tallied result (e.g., by left-clicking on the tallied result).

In accordance with the embodiment shown in FIG. 1, user comments, such as from a current user and/or previous users that have rendered the content, may be provided in a comment portion 120 in response to the comments being provided during rendering. These comments may also be provided to the content server during act 270. As shown, the comments may be rendered within the GUI 100 in temporal sequential order, relating to a temporal sequence of content corresponding to the temporal portion of the content associated with the comments. For example, comment portion 120 may show user comments that are associated with individual frames of video content rendered in the content rendering portion 110.

The comment portion 120 also may include the heat chart 190 wherein different portions of the heat chart 190 may correspond to a heat indication for the portion of the content corresponding to each of the rendered comments. Further, to facilitate temporal chunking of the comments, the comments may be grouped into predetermined and/or user determinable temporal portions, such as indicated, for example, by time indications 122. For example, the users providing comments may be enabled to indicate for what temporal portion of the content, the comment relates. In this way, the duration of the comment may be indicated by the user. The number of comments grouped in the temporal chunks may be indicated by an indication 124. The indication 124 may be useful for identifying one or more portions of the content that received large number(s) of comments and therefore may be of interest to the user. The heat chart 190, like other heat charts previously discussed, provides some indication of the type of response elicited by the content portions as discussed above, for example by utilizing a differentiation of rendering (e.g., color, shading, hatching, cross-hatching, etc.) of portions of the heat chart 190.

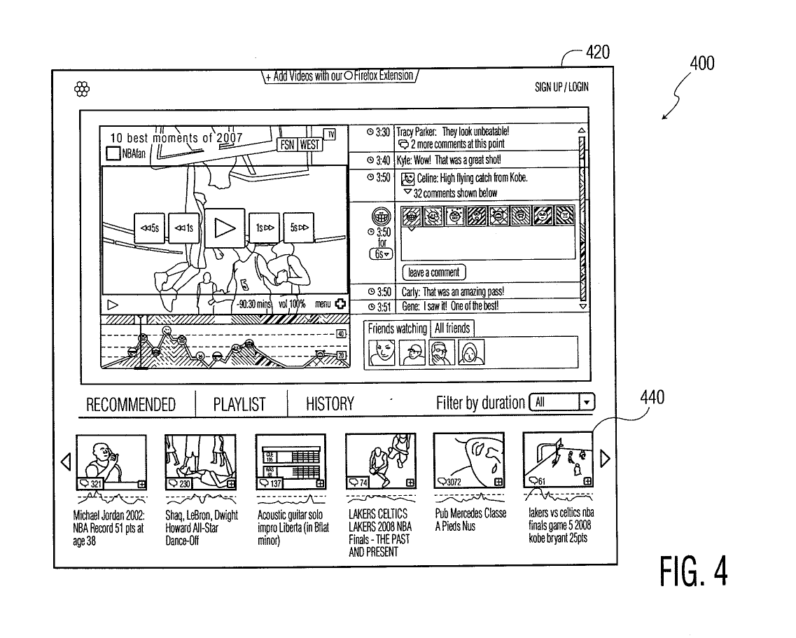

FIG. 4 shows one embodiment of the present system, wherein a GUI 400 is provided similar as the GUI 100 provided in FIG. 1 including a buddy portion 440, however, with a comment portion 420, as may be provided in response to selection of the user comment portion 120, the menu indication 114 and/or other portions of the GUI 100 as may be readily appreciated by a person of ordinary skill in the art. The comments portion 420 may include portions for user supplied reaction indications, comments, and an indication of content duration of reaction/comments, etc.

Returning to FIG. 1, the GUI 100 may also provide a playlist/history portion 160 wherein content previously selected by the user is provided. In accordance with the present system, each of the items of the playlist/history may include a simplified heat map, such as the simplified heat map 162, to provide an indication of the reaction indications associated with the content. Further, each of the items of the playlist/history may include one or more of an indication 164 of a number of reaction indications associated with the content, a summary 166 of the content and an indication 168 to facilitate addition of the content to a recommended list of content and/or a playlist.

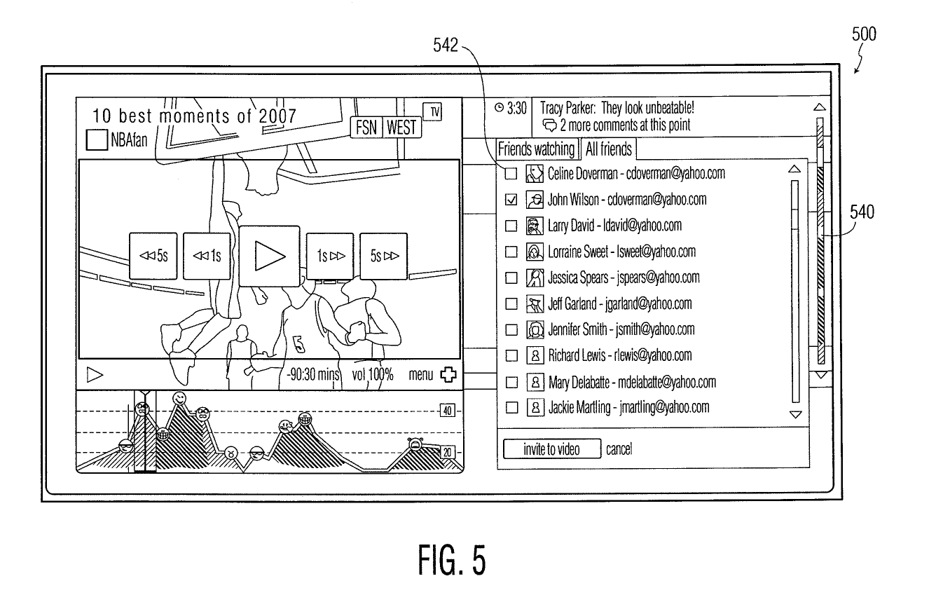

In accordance with the present system, the content server together with the user device may support a social network of user devices for purposes of sharing content, comments, reaction indications, etc. FIG. 5 shows one embodiment of the present system, wherein a GUI 500 is provided similar as the GUIs 100, 400 provided in FIGS. 1, 4, including a buddy portion 540, as may be provided in response to selection of a portion of the GUI 100, 400, etc., as may be readily appreciated by a person of ordinary skill in the art. In accordance with an embodiment of the present system, the buddy portion 540 may be utilized in accordance with an embodiment of the present system to invite “buddies” to render content currently and/or previously rendered by the user, to share playlists, recommended content, etc. The buddy portion 540 includes selection boxes 542 for selecting buddies to invite.

The present system may provide content, annotations that are associated with portions of the content, and in some embodiments, an indication as to the source (e.g., buddies) of annotations. In this way, viewers may choose content portions based on the annotation(s) from someone they know. For example, a user may choose to view a collection of frames of video content that have been annotated by a friend or someone in his or her online community. Further, the annotations including tallies of annotations, such as by a plurality of users, may be utilized to give a service provider of the user(s) a deep understanding of the content itself. In this way, the service provider may be enabled to provide advertising and/or other supplemental content that is particularly relevant to the content and/or the receiver (e.g., the user) of the content rendering (e.g., the viewer of video content, the listener of auditory content, etc.). Naturally the service provider may be enabled to provide use of the deep understanding of the content and/or the user to enable third parties to provide the advertising and/or the other supplemental content, such as more accurate targeted marketing/video advertising than heretofore enabled.

In accordance with a further embodiment of the present system, the deep understanding of the content may serve as a basis for recommendation of content by a system, for example though use of a social network.

The system application differs in one way from prior content recommendation engines as the current recommending engine may combine user explicit annotations (and commenting) of content at for example, a frame level or collection of frames for video content which may include social network information. Accordingly, the present system may have an ability to recommend content and/or provide supplemental content, such as advertising content, based on a user's current reactions (e.g., annotations) to content and based on other users who have also annotated the content, as opposed to providing the recommendation based on statistical information or simply a machine generated evaluation of the content. For example, the recommendation engine in accordance with an embodiment of the present system, may analyze the current user interaction with the content, to determine a user mood, such as exited, sad, angry. By referring to the user's history data and social network information, the recommender may generate appropriate recommendations for the user.

For example, in an embodiment wherein there is a fixed palette of eight reaction indications (e.g., emotions), designated as e1-e8. A record of each user's reaction indication selection(s) may be maintained and be analyzed at a pulse level for content, such as video content. For example, user u1 may have provided reaction indications for a video v1 which has 3 pulses p1,p2,p3. For p1, u1 may have selected e2, for p2, e4, for p3, e6. We can say u1's reaction indication signature for v1 is (e2,e4,e6). For each user and each video, a table of reaction indication results may be maintained. In this way, if u1 and u2 have similar selection patterns on most videos, for example, both user u1 and u2 have the same pattern (e2,e4,e6), or even a similar one (u1:e2,e4,e6; u2:e2,e5,e6, and e4 and e5 are similar reaction indications (e.g., emotions for example e4 is Sadness and e5 is Grief), then in accordance with an embodiment of the present system, u2's newly discovered interesting video may be recommended to u1.

In addition, the annotations including tallies of annotations, wherein the annotations are provided from a plurality of users, may be utilized to give the service provider a deep understanding of the content itself. In this way, the service provider may be enabled to provide advertising and/or other supplemental content that is particularly relevant to the content and/or the receiver (e.g., the user) of the content rendering (e.g., the viewer of video content, the listener of auditory content, etc.). Naturally the service provider may be enabled to use the deep understanding of the content and/or the user to enable third parties to provide advertising and/or other supplemental content, such as targeted marketing, such as video advertising, pop-up textual advertising, banner advertising, etc., as may be readily appreciated by a person of ordinary skill in the art.

In accordance with a further embodiment of the present system, the deep understanding of the content may serve as a basis for a recommendation of content by a system, for example through use of a social network. The system application differs in one way from prior content recommendation engines as the current recommending engine may combine user explicit annotation (e.g., reaction indications, comments, etc.) of content at for example, a frame level or collection of frames for video content, which may include social network information, such as an identification of friends from a social network (e.g., facebook, myspace) or other social networks. The present system may collect reaction indications from these friends to identify content that has been classified by these friends in accordance with the present system (e.g., reference data), that may appeal to the current user, due to similarities in classification related to other content that has been classified by both the friends and the current user. Naturally, this system of identifying similarities in classified content as reference data may be utilized even when the reference data is from third parties that are unknown to the current user since the reference data may be analyzed to identify these similarities in classification regardless of what parties provided the reference data.

Accordingly, the present system may have an ability to recommend content and/or provide supplemental content, such as advertising content, based on a user's current reactions (e.g., annotations) to content and based on other users who have also annotated the content, as opposed to providing the recommendation based on statistical information or simply based on a machine generated evaluation of the content and semantic analysis. A recommendation engine in accordance with the present system may analyze the current user interaction with the content to determine a user mood, such as exited, sad, angry. By referring to the user's historical reaction data and social network information, the recommender may be enabled to generate appropriate recommendations for the user.

For example, a user's reaction indications to a content rendering may be typically similar to another user's or plurality of user's reactions as may be determined by a system in accordance with an embodiment of the present system. By comparing a current one or more reaction indications from the user to the other “similar” user's or group of user's reaction indications (similar in a sense that typically, the reaction indications are similar) for content currently rendered by the user, a system in accordance with an embodiment of the present system may determine that the user is reacting to the rendered content in a different way then may be typical for the user. This change in reaction indications may be utilized to identify a change in mood of the user and thereby, identify content and/or content portions that may be suitable for this change in mood. In accordance with an embodiment of the present system, for example, content portions may be recommended that are uplifting (e.g., content portions that have been identified as happy) when the user has been determined to be in a sad mood. Naturally, other variations on this recommending system may be applied, such as providing content portion recommendations that compliment a better than normal mood of the user.

Further, in accordance with the present system, a recommendation may be provided to a particular portion of the content as opposed to prior systems that recommend the whole content. In this way, the user may be enabled to identify particular portions of the content that are of particular interest to the user as opposed to the entire content, wherein only particular portions may be of interest. For example, in this way, friends from a social network may explicitly recommend content, such as video content, and the recommendation may be directly to an identified portion of the content. Further, the emotion indications (responses) from the users may be analyzed so that similar patterns may be identified between users, videos and video portions. In accordance with an embodiment of the present system, a recommender system may provide recommendations based on these identified patterns.

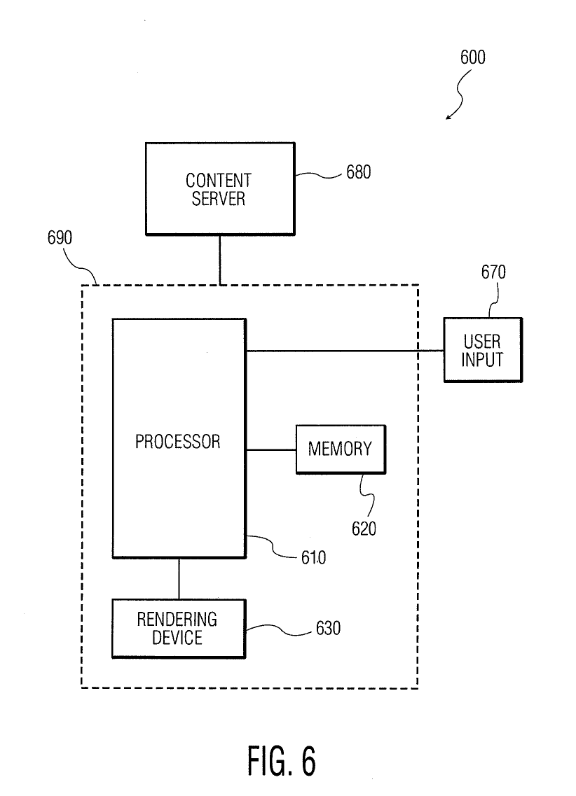

FIG. 6 shows a system 600 in accordance with an embodiment of the present system. The system 600 includes a user device 690 that has a processor 610 operationally coupled to a memory 620, a rendering device 630, such as one or more of a display, speaker, etc., a user input device 670 and a content server 680 operationally coupled to the user device 690. The memory 620 may be any type of device for storing application data as well as other data, such as content, reaction indications, tallied reaction indications, comments, graphing data, such as heat map data, heat line graph data, heat comment graph data, etc., play lists, recommended content, etc. The application data and other data are received by the processor 610 for configuring the processor 610 to perform operation acts in accordance with the present system. The operation acts include controlling at least one of the rendering device 630 to render one or more of the GUIs 100, 300, 400, 500 and/or to render content. The user input 670 may include a keyboard, mouse, trackball or other devices, including touch sensitive displays, which may be stand alone or be a part of a system, such as part of a personal computer, personal digital assistant, mobile phone, converged device, or other rendering device for communicating with the processor 610 via any type of link, such as a wired or wireless link. The user input device 670 is operable for interacting with the processor 610 including interaction within a paradigm of a GUI and/or other elements of the present system, such as to enable web browsing, content selection, such as provided by left and right clicking on a device, a mouse-over, pop-up menu, etc., such as provided by user interaction with a computer mouse, etc., as may be readily appreciated by a person of ordinary skill in the art.

In accordance with an embodiment of the present system, the rendering device 630 may operate as a touch sensitive display for communicating with the processors 610 (e.g., providing selection of a web browser, a Uniform Resource Locator (URL), portions of web pages, etc.) and thereby, the rendering device 630 may also operate as a user input device. In this way, a user may interact with the processor 610 including interaction within a paradigm of a UI, such as to support content selection, input of reaction indications, comments, etc. Clearly the user device 690, the processor 610, memory 620, rendering device 630 and/or user input device 670 may all or partly be portions of a computer system or other device, and/or be embedded in a portable device, such as a mobile telephone, personal computer (PC), personal digital assistant (PDA), converged device such as a smart telephone, etc.

The system and method described herein address problems in prior art systems. In accordance with an embodiment of the present system, the user device 690, corresponding user interfaces and other portions of the system 600 are provided for browsing content, selecting content, providing reaction indications, reaction indication palettes, etc., and for transferring the content and reaction indications, tallied reaction indications, etc., between the user device 690 and the content server 680.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 620 or other memory coupled to the processor 610.

The computer-readable medium and/or memory 620 may be any recordable medium (e.g., RAM, ROM, removable memory, CD-ROM, hard drives, DVD, floppy disks or memory cards) or may be a transmission medium utilizing one or more of radio frequency (RF) coupling, Bluetooth coupling, infrared coupling etc. Any medium known or developed that can store and/or transmit information suitable for use with a computer system may be used as the computer-readable medium and/or memory 620.

Additional memories may also be used. The computer-readable medium, the memory 620, and/or any other memories may be long-term, short-term, or a combination of long-term and short-term memories. These memories configure processor 610 to implement the methods, operational acts, and functions disclosed herein. The operation acts may include controlling the rendering device 630 to render elements in a form of a UI and/or controlling the rendering device 630 to render other information in accordance with the present system.

The memories may be distributed (e.g., such as a portion of the content server 680) or local and the processor 610, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within memory 620, for instance, because the processor 610 may retrieve the information from the network for operation in accordance with the present system. For example, a portion of the memory as understood herein may reside as a portion of the content server 680. Further, the content server 680 should be understood to include further network connections to other devices, systems (e.g., servers), etc. While not shown for purposes of simplifying the following description, it is readily appreciated that the content server 680 may include processors, memories, displays and user inputs similar as shown for the user device 690, as well as other networked servers, such as may host web sites, etc. Accordingly, while the description contained herein focuses on details of interaction within components of the user devices 690, it should be understood to similarly apply to interactions of components of the content server 680.

The processor 610 is capable of providing control signals and/or performing operations in response to input signals from the user input device 670 and executing instructions stored in the memory 620. The processor 610 may be an application-specific or general-use integrated circuit(s). Further, the processor 610 may be a dedicated processor for performing in accordance with the present system or may be a general-purpose processor wherein only one of many functions operates for performing in accordance with the present system. The processor 610 may operate utilizing a program portion, multiple program segments, or may be a hardware device utilizing a dedicated or multi-purpose integrated circuit.

Finally, the above discussion is intended to be merely illustrative of the present system and should not be construed as limiting the appended claims to any particular embodiment or group of embodiments. For example, the present system may be utilized to recommend content, supplemental content, etc., that has a high relevance to characteristics of content currently being rendered. The present system may be provided in a form of a content rendering device, such as a video player, that is enabled to provide a palette of reaction indications that include, for example, one or more user supplied and/or selected annotations/reactions. Although generally the annotations are described as associated with content portions above, the reaction indications may be used to annotate content at a specific point in the content, such as a frame level for a given video. A player in accordance with an embodiment of the present system may provide functionality to enable annotations of content including associations with corresponding content portions. A further embodiment of the present system, may provide a user interface that operates as a browser extension, such as a rendered browser toolbar, that can build a content rendering playlist, such as a video playlist. In addition, the present system may recommend content while a user is browsing the Internet. Content may be selected for rendering, annotation, etc., by manually dragging and dropping content links to a toolbar and/or other indication by the user. Further, content from a playlist may and/or recommended content may be rendered as a customized content channel, such as a video channel, and/or may be shared with friends.

Thus, while the present system has been described with reference to exemplary embodiments, including user interfaces, it should also be appreciated that numerous modifications and alternative embodiments may be devised by those having ordinary skill in the art without departing from the broader and intended spirit and scope of the present system as set forth in the claims that follow. Further, while exemplary user interfaces are provided to facilitate an understanding of the present system, other user interfaces may be provided and/or elements of one user interface may be combined with another of the user interfaces in accordance with further embodiments of the present system.

The section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

1. A method of content classification comprising acts of:
rendering content;
providing to a user a plurality of reaction indications;
receiving a user selection of one of the plurality of reaction indications; and
associating the user selected reaction indication with a portion of the content that is being rendered at the time of receiving the user selection.

2. The method of claim 1, wherein the reaction indications are pictorial representations of a limited number of potential user reactions to the rendered content.

3. The method of claim 2, wherein the reaction indications are emoticons.

4. The method of claim 2, wherein the reaction indications are representative of potential user emotional reactions to the rendered content.

5. The method of claim 1, comprising acts of:
receiving the user selected reaction indication from a plurality of users in response to the rendered content;
tallying the user selected reaction indications from the plurality of users to produce a tallied reaction indication; and
providing the tallied reaction indication to the user along with the content.

6. The method of claim 5, wherein the act of providing the tallied reaction indication comprises an act of associating the tallied reaction indication with a portion of the content.

7. The method of claim 5, wherein the tallied reaction indication is one of a plurality of tallied reaction indications, and wherein the act of providing the tallied reaction indications comprises an act of associating each of the tallied reaction indications with a different portion of the content.

8. The method of claim 5, wherein each of the user selected reaction indications are associated with a timestamp identifying a temporal point in the rendered content, the method comprising acts of:
determining a standard deviation of the timestamps; and
associating each nearest neighbor pair of reaction indications to a corresponding cluster if the corresponding nearest neighbor pair of timestamps is equal or less than the standard deviation.

9. The method of claim 8, comprising an act of identifying a portion of the content based on the timestamps of reaction indications corresponding to a given cluster.

10. The method of claim 1, comprising acts of:
comparing the user selected reaction indication with other users reaction indications for the content;
recommending further content to the user based on the comparing act.

11. A computer program stored on a computer readable memory medium, the computer program configured for classifying content, the computer program comprising:
a program portion configured to render content;
a program portion configured to provide to a user a plurality of reaction indications;
a program portion configured to receive a user selection of one of the plurality of reaction indications; and
a program portion configured to associate the user selected reaction indication with a portion of the content that is being rendered at the time of receiving the user selection.

12. The computer program of claim 11, wherein the program portion configured to provide to the user the plurality of reaction indications is configured to provide the reaction indications as pictorial representations of a limited number of potential user reactions to the rendered content.

13. The computer program of claim 12, wherein the program portion configured to provide to the user the plurality of reaction indications is configured to provide the reaction indications as emoticons.

14. The computer program of claim 12, wherein the program portion configured to provide to the user the plurality of reaction indications is configured to provide the reaction indications as pictorial representations of potential user emotional reactions to the rendered content.

15. The computer program of claim 11, the computer program comprising:
a program portion configured to receive the user selected reaction indication from a plurality of users in response to the rendered content;
a program portion configured to tally the user selected reaction indications from the plurality of users to produce a tallied reaction indication; and
a program portion configured to provide the tallied reaction indication to the user along with the content.

16. The method of claim 15, wherein the program portion configured to provide the tallied reaction indication comprises a program portion configured to associate the tallied reaction indication with a portion of the content.

17. The computer program of claim 15, wherein the tallied reaction indication is one of a plurality of tallied reaction indications, and wherein the program portion configured to provide the tallied reaction indication comprises a program portion configured to associate each of the tallied reaction indications with a different portion of the content.

18. The computer program of claim 15, wherein each of the user selected reaction indications are associated with a timestamp identifying a temporal point in the rendered content, the computer program comprising:
a program portion configured to determine a standard deviation of the timestamps; and
a program portion configured to associate each nearest neighbor pair of reaction indications to a corresponding cluster if the corresponding nearest neighbor pair of timestamps is equal or less than the standard deviation.

19. The computer program of claim 18, comprising a program portion configured to identify a portion of the content based on the timestamps of reaction indications corresponding to a given cluster.

20. The computer program of claim 11, comprising:
a program portion configured to compare the user selected reaction indication with other users reaction indications for the content;
a program portion configured to recommend further content to the user based on the comparison.
